(19) United States
(12) Patent Application Publication
(10) Pub. No.: US 2012/0045699 A1
(43) Pub. Date: Feb. 23, 2012

(54) Fuel Cell Power and Water Generation

(76) Inventors: Shailesh Atreya, Irvine, CA (US); David Whelan, Newport Coast, CA (US); Marianne E. Mata, Dana Point, CA (US); Tina R. Stoia, Rancho Santa Margarita, CA (US); David Gill, Huntington Beach, CA (US)

(21) Appl. No.: 12/859,976

(22) Filed: Aug. 20, 2010

(51) Int. Cl. H01M 8/16; H01M 8/10; H01M 8/06

(52) U.S. Cl. 429/401; 429/408; 429/410; 429/423

(57) ABSTRACT

Methods and systems provide for the creation of power, water, and heat utilizing a fuel cell. According to embodiments described herein, fuel is provided to a fuel cell for the creation of power and a fuel byproduct. The fuel byproduct is routed to a byproduct separation phase of a power and water generation system, where water is separated from the fuel byproduct. The remaining mixture is reacted in a burner phase of the system to create additional heat that may be converted to mechanical energy and/or utilized with other processes within the system or outside of the system. According to other aspects, the separated water may be utilized within a biofuel production subsystem for the creation of biofuel to be used by the fuel cell.

### BACKGROUND

Many remote bases or other facilities utilize fuel cells for the generation of power. For example, in military applications, forward operating bases are often set up at remote locations not serviced by a fixed power grid. Fuel cells provide one means for supplying the necessary power to sustain the base operations. Similarly, in civilian applications such as disaster response scenarios, power generation is a critical consideration for response teams since permanent power grids are commonly unavailable. Like power, water is another integral component for sustaining operations at many remote locations. Many remote locations do not have the functional infrastructure to provide electricity or water, or the fuel necessary to generate the required electricity.

Due to the lack of suitable infrastructure at many of these locations, fuel and water must be transported to the forward operating bases or emergency response locations, often over great distances. Transporting these items via aircraft, trains, ships, trucks and/or other vehicles is a costly and often dangerous operation. In the military context, for example, fuel and water make up a significant portion of the cargo that is trucked to remote bases. The convoys associated with these shipments not only operate at a significant expense corresponding to fuel, vehicle maintenance, and manpower, but also expose personnel to hazards associated with operating in hostile environments.

It is with respect to these considerations and others that the disclosure made herein is presented.

### SUMMARY

It should be appreciated that this Summary is provided to introduce a selection of concepts in a simplified form that are further described below in the Detailed Description. This Summary is not intended to be used to limit the scope of the claimed subject matter.

Methods and systems described herein provide for the creation of power, water, and heat utilizing a fuel cell system. According to one aspect of the disclosure provided herein, fuel is received and utilized within a fuel cell to generate power and a fuel byproduct. Multiple fuel types may be used, such as natural gas, military logistics fuel (e.g. JP5, JP8 etc.), hydrogen, and others. Water is separated from the fuel byproduct to create a conditioned fuel byproduct and water. The conditioned fuel byproduct is burned or otherwise reacted to create heat or electricity. The power, water, and heat are provided for use within these and other systems, or for general consumption.

According to another aspect, a power and water generation system includes a fuel cell, a byproduct separation phase, and a burner phase. The byproduct separation phase is positioned downstream of the fuel cell and is configured to separate water from the fuel byproduct to create water and a conditioned fuel byproduct. The burner phase is positioned downstream of the byproduct separation phase and is configured to burn the conditioned fuel byproduct to create heat that can be used within the power and water generation system, or outside of the system.

According to yet another aspect, a power and water generation system includes a biofuel production subsystem, a fuel conditioner phase, a fuel cell, a byproduct separation phase, and a burner phase. The biofuel production subsystem utilizes water from the byproduct separation phase and other biofuel production ingredients to create a biofuel to be used by the fuel cell in the generation of power and ultimately water. The fuel conditioner phase prepares the biofuel for consumption by the fuel cell. The fuel cell converts the conditioned biofuel to power and a fuel byproduct. The byproduct separation phase is positioned between the fuel cell and the burner phase and is configured to remove water from the fuel byproduct and to provide the water to the biofuel production subsystem. The remaining mixture may be combusted in the burner phase to create heat that may be converted to mechanical energy or used in other processes or otherwise reacted to produce electricity.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

FIG. 1 is a block diagram showing a comparison between a conventional power and water supply system to a fuel cell power and water generation system according to various embodiments presented herein;

FIG. 2 is a block diagram showing a fuel cell power and water generation system according to various embodiments presented herein;

FIG. 3 is block diagram showing fuel conditioner, byproduct separation, and burner phases of a fuel cell power and water generation system according to various embodiments presented herein;

FIG. 4 is a block diagram showing an illustrative fuel cell power and water generation system utilizing biofuel created with generated water according to various embodiments presented herein; and

FIG. 5 is a flow diagram illustrating a method for generating power and water with a fuel cell system according to various embodiments presented herein.

### DETAILED DESCRIPTION

The following detailed description is directed to methods and systems for creating and capturing usable water during highly efficient electrical power generation. As discussed briefly above, transporting large quantities of fuel and water to forward operating bases and other remote locations is a costly, inefficient, and often dangerous process. Utilizing the concepts and technologies described herein, a fuel cell generation system is used not only to generate electrical power, but also to generate water that may be easily filtered for potable uses or to be routed in all or part into a biofuel creation process to generate the fuel used within the fuel cell for creating electricity.

Throughout this disclosure, the various embodiments will be described with respect to use with a military forward operating base, such as would be used by military forces on a temporary or semi-permanent basis at a remote location that does not have permanent infrastructure capable of providing power and water. However, it should be understood that the disclosure provided herein is equally applicable to any type of application in which it is desirable to generate power and water in an efficient manner that decreases the quantity fuel and water that is required to be transported to the use location from a remote source location. Similarly, because the concepts described below increase the efficiency of power and water generation, the various embodiments are also suitable for any implementations in which the transportation of resources is not an issue, but in which it is desirable to operate at a lower cost, with versatility as to the type of fuel used within the system, and at decreased noise levels, as will be described in detail below.

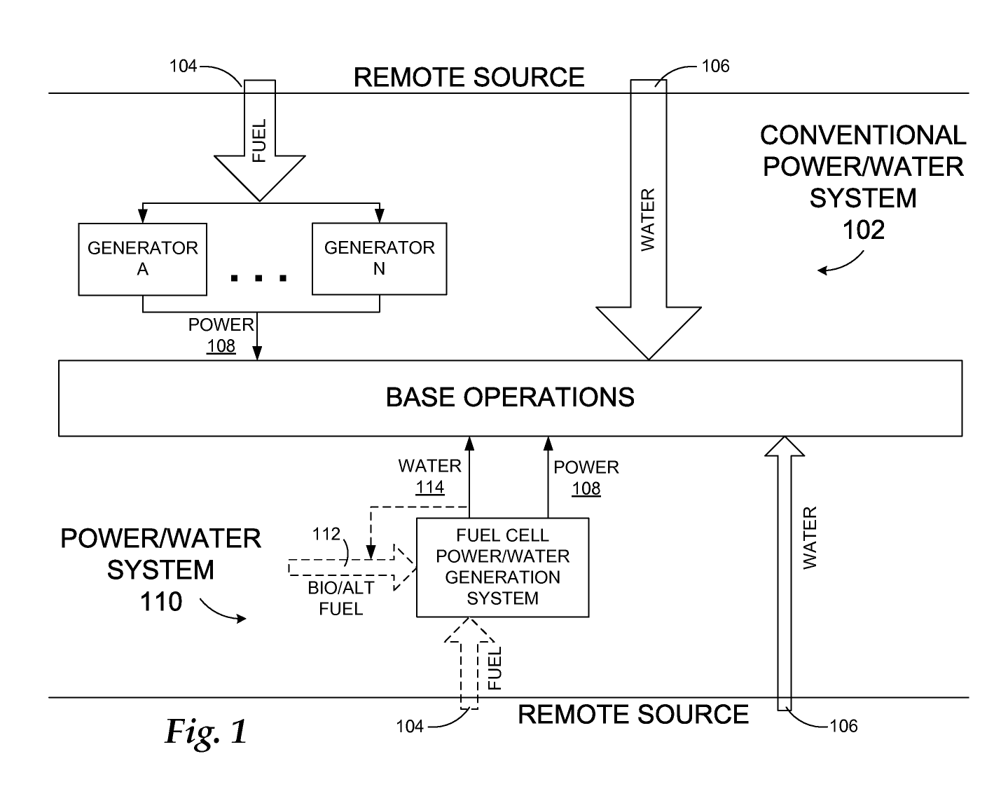

In the following detailed description, references are made to the accompanying drawings that form a part hereof, and which are shown by way of illustration, specific embodiments, or examples. Referring now to the drawings, in which like numerals represent like elements through the several figures, the efficient generation of electricity and water, among other functional byproducts such as the heated exhaust, will be described. FIG. 1 shows a comparison between a conventional power and water supply system 102 to a fuel cell power and water generation system 110 in the context of supplying power 108 and water 106/114 to support the operations of a forward operating base or other operations according to various embodiments presented herein.

A conventional power and water supply system 102 typically includes a number of generators A-N that are used to supply power 108 to base operations. To operate the generators A-N, fuel 104 is shipped in from a remote source and stored in fuel bladders at the forward operating base. Because a conventional power generation system does not generate usable water, the water 106 is shipped from a remote source and stored in bladders for use at the base.

In contrast, referring to the bottom portion of FIG. 1, a fuel cell power and water generation system 110 as described herein utilizes one or more fuel cells to create and supply the power 108 to the base. The fuel cell utilizes fuel 104 to create the power 108. As will be described further below, the fuel 104 may be a standard military fuel, such as JP-8 commonly used in military aircraft and other vehicles, a commercial fuel, such as propane or natural gas, or may be an alternative fuel 112, such as a biofuel. The generation of power 108 by the fuel cell creates a byproduct, which is typically burned off in an afterburner to create a hot exhaust product that may be used to turn a turbine or to heat a product or process.

Utilizing the embodiments described below, the water 114 is separated from the byproduct of the fuel cell prior entry into the burner phase. This water 114 can be provided for various base operations, or all or part of the water 114 may be used for creation of a fuel 112, including biofuels and other alternative fuels, to be used within the fuel cell power and water generation system 110. According to various implementations, the water 114 created by the fuel cell power and water generation system 110 may be of quantities that meet or exceed the water consumption demand of the base, or at a minimum, will decrease the amount of water 106 required to be supplied to the base from a remote source.

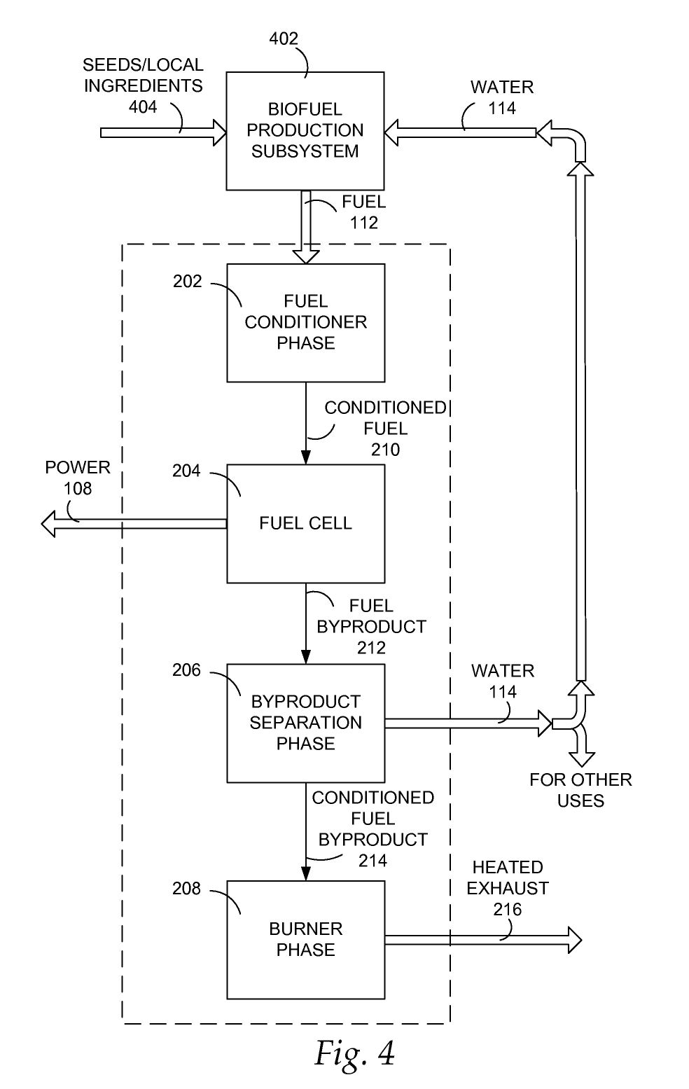

Along with decreasing the water 106 quantities shipped to the base from the remote source, the fuel cell power and water generation system 110 allows for a decrease in the quantity of fuel 104 shipped to the base due to the increase in efficiency of the fuel cell power and water generation system 110 as compared to a comparable conventional generator system as described above. Moreover, the fuel cell power and water generation system 110 may be coupled to renewable energy sources such as solar and wind power sources to provide energy during daylight periods, further reducing the quantities of fuel 104 necessary to maintain base operations. The external fuel 104 requirements may be completely eliminated in various embodiments that utilize biofuel creation and utilization, particularly when used in combination with renewable energy sources, as described in greater detail below with respect to FIG. 4.

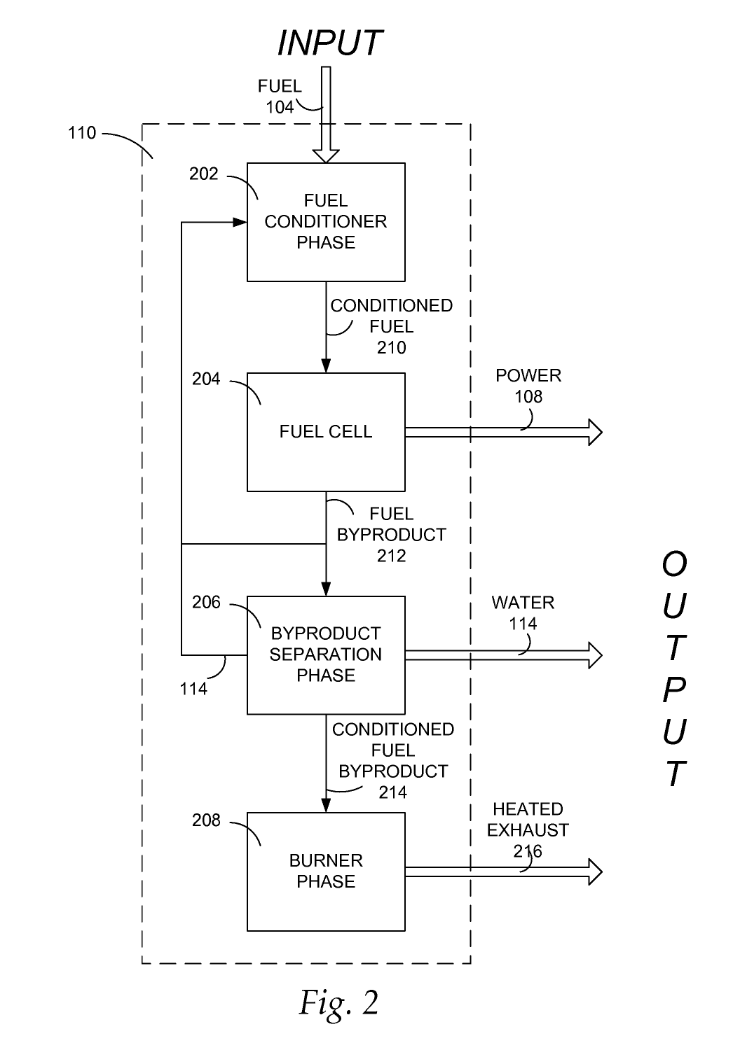

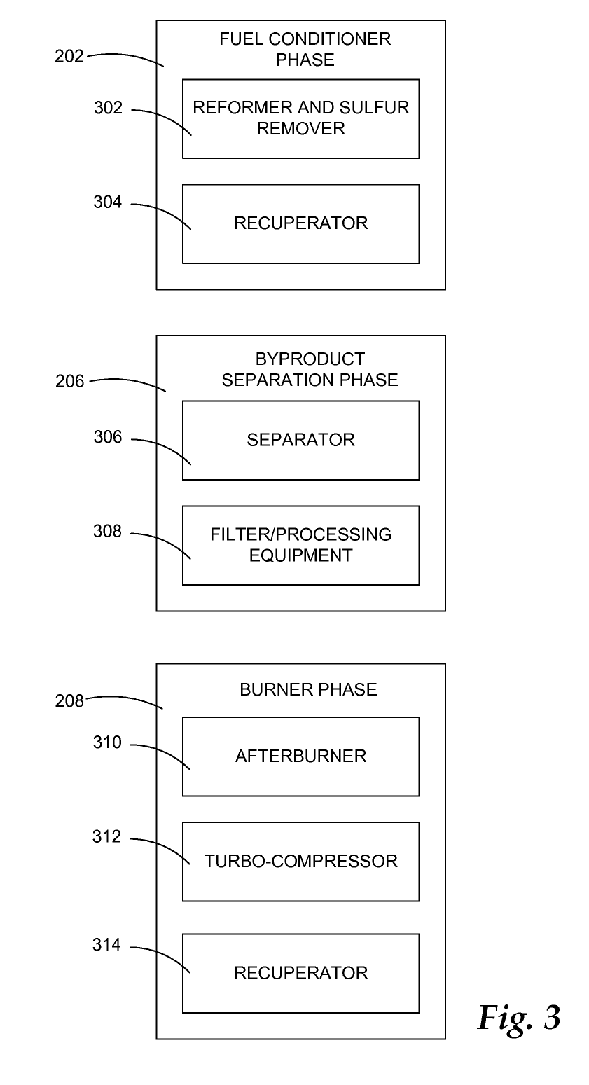

Turning now to FIG. 2, a fuel cell power and water generation system 110 will be described in further detail. According to one embodiment, the fuel cell power and water generation system 110 includes a fuel conditioning phase 202, one or more fuel cells 204, a byproduct separation phase 206, and a burner phase 208. In general, the fuel cell power and water generation system 110 receives fuel 104 as input and produces power 108, water 114, and a heated exhaust stream 216. Fuel 104, such as JP-8 or other military fuel, gasoline, hydrogen, butane, methanol, propane, or natural gas, is provided to the fuel conditioner phase 202 of the fuel cell power and water generation system 110. The fuel conditioner phase 202 includes all applicable equipment and systems used to prepare the fuel 104 for efficient use by the fuel cell 204. Specific examples of components of the fuel conditioner phase 202, as well as of the byproduct separation phase 206 and the burner phase 208, will be described below with respect to FIG. 3.

After conditioning, the conditioned fuel 210 is routed to the fuel cell 204, where it is used to create electricity, or power 108. The electrical power created by the fuel cell 204 may be direct current, but may be directed to an inverter to convert to alternating current for use with corresponding alternating current systems. It should be appreciated that although the fuel cell 204 is shown as a single generic unit for simplicity, any number and type of fuel cells 204 may be utilized within the fuel cell power and water generation system 110. As an example, the fuel cell may include one or more solid oxide fuel cells (SOFCs). One advantage other than the operating efficiency and the corresponding cost savings associated with utilizing SOFCs to generate power within the fuel cell power and water generation system 110 as compared to utilizing the generators used in a conventional power and water supply system 102 is noise reduction. Power and water generation utilizing SOFCs rather than the traditional diesel/gas generators occurs at significantly reduced noise levels, reducing the potential for harm to nearby personnel.

One byproduct of the power generation process within the fuel cell 204 is a fuel byproduct 212 that contains water vapor. Traditionally, this mixture of unutilized broken down fuel and water is routed directly to an afterburner, where the resulting exhaust stream is burned with incoming air to produce heat energy that can be captured with a turbine or used for some other purpose. However, according to the disclosure provided herein, the fuel byproduct 212 is directed at least in part to the byproduct separation phase 206, where the water vapor is separated from the unused fuel mixture of the fuel byproduct 212 to create the water 114. After proper filtering and purification, this water 114 is potable and ready for consumption or other use by base personnel. It should be noted that a portion of the fuel byproduct 212, or water 114, may be routed back to the fuel conditioner phase 202 after leaving the fuel cell 204 for reconditioning and use within the fuel cell 204. Alternatively, this reutilized fuel may be apportioned from the conditioned fuel byproduct 214 leaving the byproduct separation phase rather than from the fuel byproduct 212 after the fuel cell 204.

After separating the water 114 from the fuel byproduct 212, the remaining conditioned fuel byproduct 214 is burned within the burner phase 208 to create heated exhaust 216 or otherwise reacted to produce electricity. The heated exhaust 216 may be an exhaust stream that may be used in conjunction with a turbine or may be used to inject heat into a process. For example, the conditioner phase 202 and corresponding fuel conditioning process may include an endothermic process in which the heated exhaust 216 may be used.

Positioning the byproduct separation phase 206 in-line between the fuel cell 204 and the burner phase 208 has advantages over attempting to separate water 114 from the mixture after the burner phase 208. First, the water 114 after the burner phase 208 would be significantly more polluted since the burning process would introduce contaminants such as soot. Second, because air is being mixed in during the combustion within the burner phase 208, the water vapor is being diluted, which reduces the partial pressure of the water vapor. By separating the water vapor from the fuel byproduct 212 before the burner phase, then the partial pressure of the water vapor is much higher, allowing for a greater amount of water 114 to be separated efficiently from the mixture.

It should be understood that the block diagram of FIG. 2 is a simplified representation of the various phases and components of a fuel cell power and water generation system 110 according to embodiments discussed herein. Some exemplary components of the fuel conditioner phase 202, byproduct separation phase 206, and burner phase 208 will be described below with respect to FIG. 3. However, the specific equipment utilized will depend on the particular implementation. Equipment and controls that are not germane to the concepts described herein have been omitted for clarity. For example, the fuel cell power and water generation system 110 includes power distribution and control hardware, various system controls, and other balance of plant hardware that has not been shown or described.

Referring to FIG. 3, the fuel conditioner phase 202, byproduct separation phase 206, and burner phase 208 will be described in further detail. According to one embodiment, the fuel conditioner phase 202 includes a reformer, such as a steam reformer, and sulfur remover 302. The fuel reformation and sulfur removal breaks down the fuel 104 to various species that maximize the efficiency of the particular fuel cell 204 utilizing the fuel. The particular characteristics and operating parameters of the reformer and sulfur remover 302 depends on the type of fuel 104 being used and the characteristics of the fuel cell 104 processing the fuel. The fuel conditioner phase 202 may additionally include a recuperator to further increase the efficiency of the fuel processing prior to delivery of the fuel to the fuel cell 204.

The byproduct separation phase 206 includes a separator 306 operative to separate the water vapor from the unutilized fuel and other byproducts within the fuel byproduct 212 from the fuel cell 204. Additional filtering and purifying equipment 308 is utilized to further process the separated water to create the potable water 114 for use by base personnel and for base operations. The burner phase 208 utilizes an afterburner 310 to combust the conditioned fuel byproduct 214 and create heated exhaust 216. The created heated exhaust stream 216 may be routed to a turbo-compressor 312 within the burner phase 208, where the heated exhaust 216 is transformed to mechanical energy. A recuperator or heat exchanger 314 may again be used to increase the efficiency of the turbo-compressor 312 operation. As mentioned above, the fuel cell power and water generation system 110 and corresponding fuel conditioner 202, byproduct separation 206, and burner phases 208, may include additional or fewer components than shown and described in the accompanying figures without departing from the scope of this disclosure.

FIG. 4 shows an alternative embodiment in which the fuel cell power and water generation system 110 includes a biofuel production subsystem 402. As discussed above with respect to FIG. 1, the fuel cell power and water generation system 110 may be configured to utilize alternative fuels 112, such as biofuels. The manufacturing process for creating a biofuel can occur at the forward operating base using seeds and/or ingredients 404 that are locally found, grown, or purchased. In doing so, the reliance on importing fuel to the forward operating base is diminished or eliminated. The creation of the biofuel typically requires water. According to one embodiment shown in FIG. 4, the water 114 that is created and captured by the fuel cell power and water generation system 110 is returned to the biofuel production subsystem 402 to be used in the fuel manufacturing process. Any surplus water 114 not used by the biofuel production subsystem 402 may be routed to other base operations.

Depending on the quantity of water 114 needed to produce the required quantity of fuel 112, the fuel cell power and water generation system 110 could be a substantially stand alone, self-sustaining power and water generation process with respect to fuel and water requirements. The biofuel production subsystem would require the additional seeds and/or ingredients 404 to produce the fuel 112, but would require very little to no fuel 104 and/or water 106 to be shipped to the base from a remote source. As the seeds and/or ingredients 404 may presumably be procured locally, the dangerous and costly convoys conventionally used to ship fuel and water from remote sources may be significantly reduced or eliminated.

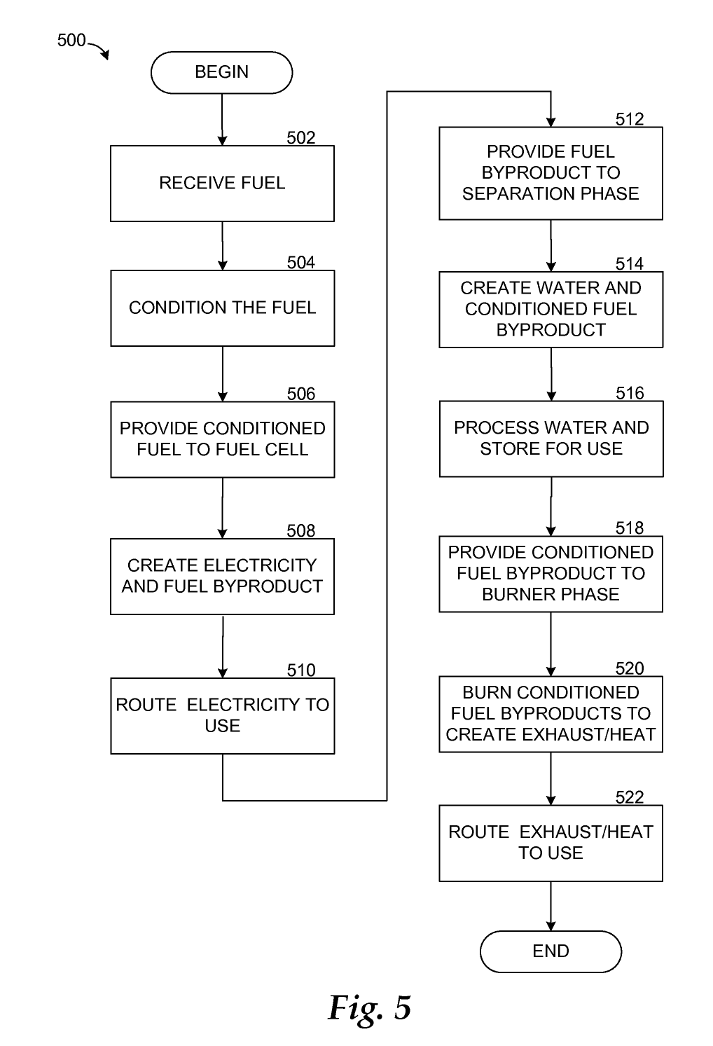

Turning now to FIG. 5, an illustrative routine 500 for creating electrical power and water, while recapturing waste heat, will now be described in detail. It should be appreciated that more or fewer operations may be performed than shown in the FIG. 5 and described herein. Moreover, these operations may also be performed in a different order than those described herein. The routine 500 begins at operation 502, where the fuel is received. As discussed above, the fuel 104 may be standard military fuel such as JP-8 or commercial fuel such as gasoline, hydrogen, butane, methanol, propane, or natural gas. Alternatively, the fuel cell power and water generation system 110 may utilize alternative fuel 112, such as a biofuel produced by a biofuel production subsystem 402 as described with respect to FIG. 4.

From operation 502, the routine 500 continues to operation 504, where the fuel 104 enters the fuel conditioner phase 202 of the fuel cell power and water generation system 110. In the fuel conditioner phase 202, operations such as reformation and sulfur removal prepare the fuel for efficient use by the fuel cell 204, creating conditioned fuel 210. At operation 506, the conditioned fuel 210 enters the fuel cell 204, where it reacts to create power 108 and a fuel byproduct 212 at operation 508. The resulting electricity is routed to the use or storage locations at operation 510.

The routine 500 continues from operation 510 to operation 512, where the fuel byproduct 212 exiting the fuel cell 204 is provided to the byproduct separation phase 206 of the fuel cell power and water generation system 110. The byproduct separation phase 206 may include any quantity and type of equipment suitable for reclaiming and processing the water 114 from the mixture leaving the fuel cell 204. As discussed above, this equipment may include a separator 306 to separate and condense the water vapor, and filtering and processing equipment to make the water 114 potable and ready for use. The water 114 is processed and stored for use at operation 516.

After separating the water 114 from the fuel mixture, the resulting conditioned fuel byproduct 214 is routed to the burner phase 208 of the fuel cell power and water generation system 110 at operation 518. The conditioned fuel byproduct 214 is burned in the afterburner or reacted in another manner 310 at operation 520 to create the heated exhaust stream 216. This exhaust stream is routed to the turbo-compressor 312 or other system at operation 522 to recoup the heat in the heated exhaust stream 216 as mechanical energy or to inject heat into another system or process, further increasing the efficiency of the fuel cell power and water generation system 110, and the routine 500 ends.

It should be clear from the above disclosure that the fuel cell power and water generation system 110 described herein and encompassed by the claims below provides a significant improvement in operating efficiency over conventional systems, effectively reducing operating costs, reducing logistical costs associated with transporting fuel and water, and decreasing the casualty risks corresponding with the hazardous transportation of fuel and water to forward operating bases. The fuel cell power and water generation system 110 utilizes fuel cell technology to increase the flexibility of the system to accept various fuels 104 and to efficiently produce power 108, reducing the fuel consumption rates of the base as compared to traditional generator sets. The use of fuel cell technology additionally reduces the hazardous noise levels associated with traditional diesel/gas generators.

The water reclamation aspects of the fuel cell power and water generation system 110 allow for the removal of water 114 from the fuel waste created during the production of power 108 by the fuel cell 204. By separating the water 114 prior to the burner phase 208 of the fuel cell power and water generation system 110, the water vapor has a higher partial pressure, which allows for increased water recovery efficiency. Separating the water vapor from the unutilized fuel mixture prior to burning the mixture additionally results in cleaner water 114 than would be available after the burner phase 208, simplifying and assisting the water processing operations to create potable water.

When coupled with a biofuel production subsystem 402, the fuel cell power and water generation system 110 may significantly reduce or eliminate the need for fuel 104 to be shipped to the forward operating base for power production and the water 114 recaptured during the byproduct separation phase 206 can be cycled into the biofuel production subsystem 402 to significantly reduce or eliminate the need for water 106 from a remote source for fuel production. Utilizing biofuel to fuel the fuel cell power and water generation system 110, further combined with the use of renewable energy sources such as solar and wind power at the forward operating base, provides an extremely efficient, stand alone energy and water production system.

Finally, recaptured heated exhaust 216 from the burner phase 208 of the fuel cell power and water generation system 110 may be utilized to further increase the efficiency of the overall system. The heated exhaust 216 may be used to drive a turbo-compressor 312, may be used in other components of the fuel cell power and water generation system 110, or used in other base systems or processes.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for generating water and power within a fuel cell system, the method comprising:
receiving fuel;
utilizing the fuel within a fuel cell to generate power and a fuel byproduct;
separating water from the fuel byproduct to create a conditioned fuel byproduct and water;
burning the conditioned fuel byproduct to create heat; and
providing the power, the water, and the heat for use.

2. The method of claim 1, further comprising conditioning the fuel prior to utilization in the fuel cell to create conditioned fuel for the fuel cell.

3. The method of claim 2, wherein conditioning the fuel prior to utilization comprises reforming the fuel and removing sulfur from the fuel.

4. The method of claim 1, wherein the fuel cell comprises a solid oxide fuel cell (SOFC).

5. The method of claim 1, wherein separating the water from the fuel byproduct comprises routing the fuel byproduct to a separator and separating the water vapor from the fuel byproduct.

6. The method of claim 1, wherein burning the conditioned fuel byproduct comprises providing the conditioned fuel byproduct to an afterburner and combusting the conditioned fuel byproduct to create an exhaust flow.

7. The method of claim 6, further comprising routing the exhaust flow through a turbo-compressor to transform heat energy to mechanical energy.

8. The method of claim 6, further comprising routing the exhaust flow to a fuel conditioner phase of the fuel cell system and provide heat to an endothermic reformation process of the fuel conditioner phase.

9. The method of claim 1, wherein the fuel is a biofuel and wherein the method further comprises producing the biofuel in a biofuel creation subsystem.

10. The method of claim 9, wherein providing the water for use comprises providing the water to the biofuel creation subsystem for use in production of the biofuel.

11. A power and water generation system, comprising:
a fuel cell configured to convert fuel into power and a fuel byproduct;
a byproduct separation phase positioned downstream of the fuel cell and configured to separate water from the fuel byproduct to create water and a conditioned fuel byproduct; and
a burner phase positioned downstream of the byproduct separation phase and configured to burn the conditioned fuel byproduct to create heat.

12. The power and water generation system of claim 11, wherein the fuel cell comprises a SOFC.

13. The power and water generation system of claim 11, wherein the byproduct separation phase comprises a separator configured to separate water from the fuel byproduct to create the water.

14. The power and water generation system of claim 13, wherein the byproduct separation phase further comprises water processing equipment configured to produce potable water from the water.

15. The power and water generation system of claim 11, wherein the burner phase comprises an afterburner configured to combust the conditioned fuel byproduct with air to create an exhaust flow comprising the heat.

16. The power and water generation system of claim 15, wherein the burner phase comprises a turbo-compressor configured to transform the exhaust flow to mechanical energy.

17. The power and water generation system of claim 15, wherein the burner phase is thermally coupled to a fuel conditioner phase comprising a reformer configured to condition the fuel for the fuel cell.

18. The power and water generation system of claim 11, wherein the fuel is a biofuel and wherein the power and water generation system further comprises a biofuel production subsystem configured to receive the water and to create the biofuel for use by the fuel cell.

19. A power and water generation system, comprising:
a biofuel production subsystem configured to receive water and biofuel ingredients and to create a biofuel;
a fuel conditioner phase configured to receive the biofuel and create conditioned fuel;
a fuel cell positioned downstream from the fuel conditioner phase and configured to convert the conditioned fuel into power and a fuel byproduct;
a byproduct separation phase positioned downstream of the fuel cell and configured to separate water from the fuel byproduct to create the water and a conditioned fuel byproduct and to provide the water to the biofuel production subsystem; and
a burner phase positioned downstream of the byproduct separation phase and configured to react the conditioned fuel byproduct to create a heated exhaust stream.

20. The power and water generation system of claim 19, wherein the fuel cell comprises a SOFC, wherein the burner phase comprises a turbo-compressor configured to transform the heat to mechanical energy, and wherein the burner phase is thermally coupled to the fuel conditioner phase to provide heat to the fuel conditioner phase during creation of the conditioned fuel.
